(19) United States
(12) Patent Application Publication
(10) Pub. No.: US 2012/0111194 A1
(43) Pub. Date: May 10, 2012

(54) Gas Mixture Separation Apparatus and Method

(75) Inventors: Mitsuru Miyagawa, Chiba (JP); Kazuyoshi Matsuo, Chiba (JP); Souichiro Sakurai, Chiba (JP); Masakazu Sakai, Tokyo (JP); Akira Kidoguchi, Tokyo (JP)

(73) Assignee: MITSUI ENGINEERING & SHIPBUILDING CO., LTD., Tokyo (JP)

(21) Appl. No.: 13/321,907

(22) PCT Filed: Mar. 30, 2010
(86) PCT No.: PCT/JP2010/055664

§ 371 Date: Jan. 24, 2012

(30) Foreign Application Priority Data
May 26, 2009 (JP) JP2009-126725

(51) Int. Cl. B01D 53/14

(52) U.S. Cl. 95/186; 261/75; 261/151

(57) ABSTRACT

To provide a gas mixture separation apparatus and a method which can reduce the energy consumption necessary to separate one type of gas, such as CO₂, from a gas mixture, such as combustion exhaust gas or process gas, to reduce the operating cost of the apparatus. A gas mixture separation apparatus includes a gas hydrate formation part for hydrating one type of gas contained in a gas mixture containing a plurality of gas components to form a gas hydrate slurry, a dehydration part for dehydrating the gas hydrate slurry, and a gas hydrate decomposition part for decomposing and regasifying the gas hydrate obtained by the dehydration, and is characterized in that the water removed from the gas hydrate slurry in the dehydration part and the water generated when the gas hydrate is decomposed in the gas hydrate decomposition part are mixed together and the mixed water is introduced into the gas hydrate formation part as circulating water.

### TECHNICAL FIELD

The present invention relates to apparatus and method for separating one type of gas contained in a gas mixture such as combustion exhaust gas or process gas.

### BACKGROUND ART

Methods that are used to separate one type of gas, such as carbon dioxide (CO₂), from combustion exhaust gas or process gas in a power generation system, such as coal-fired power generation or integrated gasification combined cycle (IGCC), or in an iron steel plant or cement plant include a chemical absorption method, a PSA method (physical adsorption method), a membrane separation method, a physical absorption method, and an oxygen combustion method.

The chemicals used in the chemical absorption method and physical absorption method are not only expensive but also highly toxic and cause environmental pollution if they leak. The PSA method (physical adsorption method) and membrane separation method require an expensive adsorbent (such as zeolite) or separation membrane (zeolite membrane or organic membrane) and also need high maintenance cost because the adsorbent or separation membrane must be periodically replaced. The oxygen combustion method requires high cost because equipment for separating oxygen from combustion air is required, and has a problem of an increase in thermal NOx resulting from high-oxygen combustion.

A hydrate separation method, in which CO₂ in a gas such as combustion exhaust gas or process gas is separated from the gas by hydrating the CO₂, is attracting attention as the cleanest method because only water is used to separate CO₂.

However, the hydrate separation method tends to require relatively high operating cost because pressurizing and cooling processes are required to form a gas hydrate such as CO₂ hydrate and because energy is necessary to heat the gas hydrate at a relatively low temperature when the gas hydrate is decomposed (regasified) to use the separated gas.

In Patent Document 1, CO₂ in combustion exhaust gas is hydrated and separated, and the energy that is generated when the separated CO₂ hydrate is regasified into CO₂ is recovered by a power recovery device, such as a gas expersion, thereby reducing the power for compression in the entire operation.

### RELATED ART DOCUMENT

### Patent Document

Patent Document 1: US 2007/0248527A1

### SUMMARY OF THE INVENTION

### Problem to be Solved by the Invention

In view of the energy problems and environmental problems resulting from the energy problems, further energy saving is required. It is, therefore, an object of the present invention to provide a gas mixture separation apparatus and a method which can reduce the energy consumption necessary to separate one type of gas, such as CO₂, from a gas mixture, such as combustion exhaust gas or process gas, to reduce the operating cost of the apparatus.

### Means for Solving the Problem

For the purpose accomplishing the above object, a gas mixture separation apparatus according to a first aspect of the present invention includes a gas hydrate formation part for hydrating one type of gas contained in a gas mixture containing a plurality of gas components to form a gas hydrate slurry, a dehydration part for dehydrating the gas hydrate slurry, and a gas hydrate decomposition part for decomposing and regasifying the gas hydrate obtained by the dehydration, and is characterized in that the water removed from the gas hydrate slurry in the dehydration part and the water generated when the gas hydrate is decomposed in the gas hydrate decomposition part are mixed together and the mixed water is introduced into the gas hydrate formation part as circulating water.

A gas hydrate is usually formed under high-pressure and low-temperature conditions although the conditions vary depending on the type of the gas to be hydrated. For example, carbon dioxide (CO₂) in an exhaust gas is hydrated at 5 to 20 MPa and 0 to 4° C. depending on the CO₂ concentration.

The one type of gas separated from the gas mixture in the gas hydrate formation part can be regasified and used. The water generated by the decomposition of the gas hydrate during the regasification is returned to the gas hydrate formation part and used again. Here, decomposition heat with a relatively low temperature is required to decompose the gas hydrate, and the water generated by the decomposition has a temperature of approximately 10 to 15° C. Thus, when the water generated by the decomposition is returned to the gas hydrate formation part, it needs to be cooled to a low temperature suitable for the formation of the gas hydrate.

On the other hand, the gas hydrate slurry formed in the gas hydrate formation part is dehydrated in the dehydration part, and the temperature of the water removed from the gas hydrate slurry is as low as that in the gas hydrate formation part.

According to this aspect, a dehydration part is provided between the gas hydrate formation part and the gas hydrate decomposition part and the water removed from the gas hydrate slurry in the dehydration part (having as low a temperature as in the hydrate formation part) and the water generated by the decomposition of the gas hydrate in the gas hydrate decomposition part (having a slightly higher temperature) are mixed. Therefore, the mixed water has a temperature which is lower than that of the water generated by the decomposition of the gas hydrate and the energy necessary to cool the mixed water (circulating water) can be reduced compared to the case where only the water generated by the decomposition of the gas hydrate is returned to the gas hydrate formation part. In addition, because the dehydrated high-concentration hydrate slurry is regasified, the thermal decomposition energy necessary for the regasification can be also reduced.

A gas mixture separation apparatus according to a second aspect of the present invention includes a gas hydrate formation part for hydrating one type of gas contained in a gas mixture containing a plurality of gas components to form a gas hydrate slurry, a dehydration part for dehydrating the gas hydrate slurry, a gas hydrate decomposition part for decomposing and regasifying the gas hydrate obtained by the dehydration, and a gas release part for receiving the water obtained as a result of the regasification in the gas hydrate decomposition part and releasing the one type of gas dissolved in the water, and is characterized in that the water removed from the gas hydrate slurry in the dehydration part and the water passed through the gas release part are mixed together and the mixed water is introduced into the gas hydrate formation part as circulating water.

The gas separated from the gas mixture is dissolved in the water obtained as a result of regasification of the gas hydrate in the gas hydrate decomposition part. In general, the solubility of a gas in water tends to increases as the pressure increases or as the temperature decreases. In particular, it is known that carbon dioxide has much higher water solubility than other gas components (such as hydrogen and nitrogen) contained in the gas mixture, and the dissolution of the gas in the water decreases the gas separation efficiency.

Here, if the hydrate is decomposed at a higher temperature in the gas hydrate decomposition part, the dissolution of the gas in the water decreases. However, when the water increased in temperature is returned to the gas hydrate formation part, the energy consumption necessary to cool the water (circulating water) increases. On the other hand, if the hydrate is decomposed at a lower pressure in the gas hydrate decomposition part, the dissolution of the gas in the water decreases. However, when the gas hydrate is delivered from the dehydration part to the gas hydrate decomposition part, the pressure in the gas hydrate decomposition part must be increased to a level at which the gas hydrate does not decompose (high pressure) and the energy consumption necessary to pressurize the gas hydrate decomposition part again increases.

In this aspect, the gas release part is provided separately from the gas hydrate decomposition part. The water obtained as a result of the regasification in the gas hydrate decomposition part is delivered to the gas release part, and the gas (gas separated from the gas mixture) contained in the water obtained as a result of the regasification is released from the water in the gas release part. The resulting water is mixed with the water removed from the gas hydrate slurry, and the mixed water is introduced into the gas hydrate formation part as circulating water.

According to this aspect, the gas hydrate decomposition part and the gas release part are provided separately. Thus, when the gas hydrate is decomposed in the gas hydrate decomposition part, a higher temperature can be applied as a gas hydrate decomposition condition without reducing the pressure so much. For example, when carbon dioxide is hydrated, the gas hydrate formation part and the dehydration part can be set at 6 to 9 MPa and 2 to 4° C., and the gas hydrate decomposition part can be set at approximately 4 MPa and 10° C. In other words, the differences in the pressure and temperature conditions between the hydrate formation part or the dehydration part and the gas hydrate decomposition part can be small when the gas hydrate is decomposed.

Then, when the water obtained by the decomposition of gas hydrate is delivered to the gas release part and the gas dissolved in the water is released in the gas release part, the gas can be released from the water while the temperature in the gas release part is set low by setting the pressure in the gas release part low. For example, when the carbon dioxide as described above is hydrated, the pressure and temperature in the gas release part can be set at 0.2 to 0.5 MPa and approximately 10° C., respectively.

When the pressure in the gas release part is set low, the pressure in the gas hydrate decomposition part decreases when the water is transported from the gas hydrate decomposition part to the gas release part but it is only necessary to pressurize the gas hydrate decomposition part to compensate for the pressure drop that occurs during the transportation of the water. Thus, the energy consumption necessary to repressurize the gas hydrate decomposition part can be reduced compared to the case where the dissolution of the gas obtained by the decomposition of the gas hydrate in the water is reduced by decreasing the pressure in the gas hydrate decomposition part as described above.

The water passed through the gas release part is mixed with the water removed from the gas hydrate slurry in the dehydration part, and the mixed water is introduced into the gas hydrate formation part as circulating water. Because the gas release part is provided separately from the gas hydrate decomposition part, there is no need to increase the temperature of the water to release the gas because the gas can be released by reducing the pressure. Therefore, the energy necessary to cool the water to be returned to the gas hydrate formation part as the circulating water can be reduced. Preferably, heating is carried in the gas release part out to an extent that compensates for the releasing heat that is necessary to release the gas from the water.

As described above, the gas separation efficiency can be improved by releasing the gas in the water obtained as a result of regasification of the gas hydrate in the gas hydrate decomposition part, and cost reduction can be achieved by reducing the energy consumption necessary to operate the gas mixture separation apparatus.

According to a third aspect of the present invention, the gas mixture separation apparatus as described in the first or second aspect further includes a compressor, provided upstream of the gas hydrate formation part, for pressurizing the gas mixture to a predetermined pressure, and is characterized in that the pressure energy of non-hydrated high-pressure gas discharged from the gas hydrate formation part is used as power for the compressor.

Because a gas hydrate is formed under high-pressure and low-temperature conditions as described above, the gas mixture is compressed and pressurized in the compressor before being supplied to the gas hydrate formation part.

The residual gas (non-hydrated gas) after the formation of gas hydrate of the one type of gas contained in the gas mixture in the gas hydrate formation part still has a high pressure when discharged out of the gas hydrate formation part.

According to this aspect, the pressure energy of the high-pressure gas after the hydration and removal of one type of gas in the gas mixture, that is, non-hydrated high-pressure gas, can be used as power for the compressor to reduce the energy consumption in the compressor. Therefore, the overall operating cost of the apparatus can be reduced.

According to a fourth aspect of the present invention, the gas mixture separation apparatus as described in the third aspect further includes a cooling part for cooling the circulating water using the cold energy which is generated when the high-pressure gas is expanded to atmospheric pressure.

According to this aspect, the cold energy which is generated when the non-hydrated high-pressure gas is expanded to atmospheric pressure can be used to cool the circulating water when the pressure energy of the high-pressure gas is used as power for the compressor. This reduces the energy consumption required to cool the circulating water. Therefore, the overall operating cost of the apparatus can be reduced.

According to a fifth aspect of the present invention, the gas mixture separation apparatus as described in any of the first to fourth aspects is characterized in that the gas that is hydrated is carbon dioxide. According to this aspect, the same effect as that of any one of first to fourth aspects can be obtained, and carbon dioxide can be separated from a gas mixture by a hydration process.

According to a sixth aspect of the present invention, the gas mixture separation apparatus as described in any of the first to fifth aspects is characterized in that the gas mixture is a mixed gas of a useful gas component and a useless gas component, and the gas that is hydrated is the useless gas component.

Here, the term “useful gas component” refers to a gas component that is useful for a specific application. The term “useless gas component” includes not only a gas component that is useless for the specific application but also a component which, when present, limits or interferes with the application of the useful gas component.

According to this aspect, the same effect as that of any one of first to fifth aspects can be obtained, and a useless gas component can be separated from a gas mixture by a hydration process. Therefore, a useful gas component can be concentrated and purified.

A gas mixture separation method according to a seventh aspect of the present invention includes a gas hydrate formation step of hydrating one type of gas contained in a gas mixture containing a plurality of gas components to form a gas hydrate slurry, a dehydration step of dehydrating the gas hydrate slurry, and a gas hydrate decomposition step of decomposing and regasifying the gas hydrate obtained by the dehydration, and is characterized in that the water removed from the gas hydrate slurry in the dehydration step and the water generated when the gas hydrate is decomposed in the gas hydrate decomposition step are mixed together and the mixed water is circulated as water for use in forming the gas hydrate in the gas hydrate formation step. According to this aspect, the same effect as that of the first aspect can be obtained.

A gas mixture separation method according to an eighth aspect of the present invention includes a gas hydrate formation step of hydrating one type of gas contained in a gas mixture containing a plurality of gas components to form a gas hydrate slurry, a dehydration step of dehydrating the gas hydrate slurry, a gas hydrate decomposition step of decomposing and regasifying the gas hydrate obtained by the dehydration, and a gas release step for receiving the water obtained as a result of the regasification in the gas hydrate decomposition step and releasing the one type of gas dissolved in the water, and is characterized in that the water removed from the gas hydrate slurry in the dehydration step and the water passed through the gas release step are mixed together and the mixed water is circulated as water for use in forming the gas hydrate in the gas hydrate formation step. According to this aspect, the same effect as that of the second aspect can be obtained.

A gas mixture separation method according to a ninth aspect of the present invention is characterized in that the gas that is hydrated in the seventh or eighth aspect is carbon dioxide.

According to this aspect, the same effect as that of seventh or eighth aspect can be obtained, and carbon dioxide can be separated from a gas mixture by a hydration process.

### Effect of the Invention

According to the present invention, the energy consumption necessary to hydrate and separate one type of gas contained in a gas mixture can be reduced to reduce the operating cost of the apparatus.

### BRIEF DESCRIPTION OF DRAWINGS

FIG. 1 is a schematic configuration diagram illustrating a gas mixture separation apparatus according to one embodiment of the present invention.

FIG. 2 is a schematic configuration diagram illustrating a gas mixture separation apparatus according to another embodiment of the present invention.

FIG. 3 is a schematic configuration diagram illustrating a gas mixture separation apparatus according to yet another embodiment of the present invention.

FIG. 4 is a schematic configuration diagram illustrating a gas mixture separation apparatus according to still yet another embodiment of the present invention.

### EMBODIMENT OF THE INVENTION

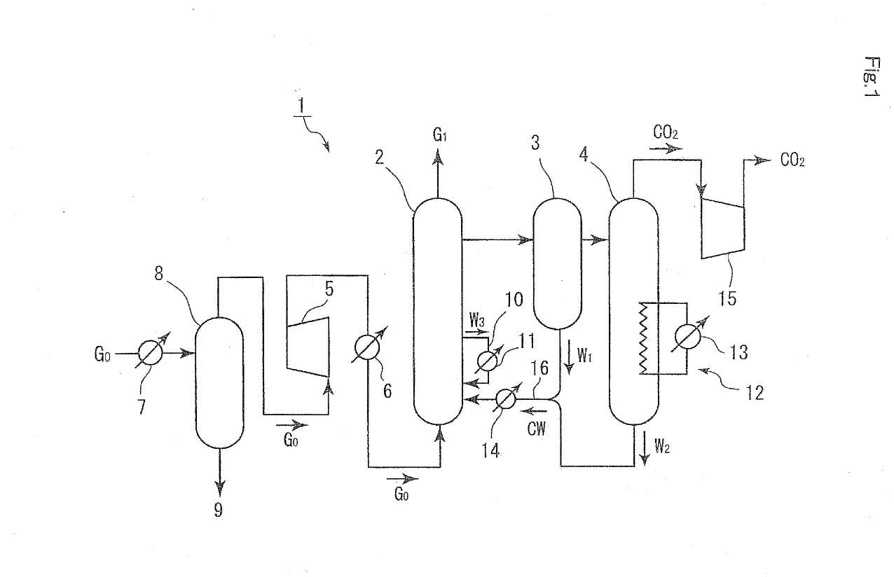

While description is hereinafter made of the present invention in detail based on examples, the present invention is not limited to the examples. One embodiment of a gas mixture separation apparatus according to the present invention is described with reference to FIG. 1. FIG. 1 is a schematic configuration diagram illustrating a gas mixture separation apparatus according to one embodiment of the present invention.

### First Embodiment

A gas mixture separation apparatus 1 according to this embodiment has a gas hydrate formation part 2 for hydrating one type of gas contained in a gas mixture G₀ to form a gas hydrate slurry, a dehydration part 3 for dehydrating the gas hydrate slurry, and a gas hydrate decomposition part 4 for decomposing and regasifying the gas hydrate obtained by the dehydration.

A compressor 5, such as a centrifugal compressor, and a gas cooler 6 for adjusting the gas mixture G₀ to predetermined pressure and temperature at which the one type of gas is hydrated are provided upstream of the gas hydrate formation part 2.

The gas mixture G₀, such as combustion exhaust gas or process gas, usually has a high temperature of approximately 40 to 200° C. and contains a small amount of drain 9, such as water (water vapor), oil, ash or dust. Thus, the gas mixture G₀ is cooled to a predetermined temperature (such as approximately 40° C.) in a gas cooler 7 before being delivered to the compressor 5 and is supplied to the gas hydrate formation part 2 after removal of the drain 9 in a drain remover 8, such as a mist separator, cyclone or water scrubber.

In this embodiment, a case where carbon dioxide (CO₂) in the gas mixture G₀ is hydrated and separated is described. CO₂ hydrate can be formed at 5 to 20 MPa and 0 to 4° C., for example, although it depends on the CO₂ concentration. The gas mixture G₀ is brought to a condition suitable for the formation of CO₂ hydrate as described above in the compressor 5 and the gas cooler 6 and then is supplied to the gas hydrate formation part 2. It is desirable that the gas mixture G₀ is cooled to a temperature of approximately 0 to 1° C., for example, in the gas cooler 6 and blown into the gas hydrate formation part 2 set at approximately 4° C. in view of the fact that heat is generated during the formation of CO₂ hydrate to increase the temperature in the gas hydrate formation part 2.

The gas hydrate formation step in the gas hydrate formation part 2 can be carried out by a known method, such as a bubbling method in which fine bubbles are blown into water or a spraying method in which water is sprayed into a gas. In particular, the bubbling method is preferred because the gas-liquid contact efficiency is high and an intended gas hydrate can be formed efficiently.

When CO₂ hydrate is formed, 65.2 kJ of heat of formation is generated per mole of CO₂. To prevent temperature rise in the gas hydrate formation part 2 by the heat of formation and maintain the interior of the gas hydrate formation part 2 at a predetermined temperature (approximately 4° C., for example), a line 10 is provided to extract water W₃ from the gas hydrate formation part 2 to be circulated and the water W₃ is cooled to approximately 0 to 1° C. in a cooler 11, for example.

The CO₂ in the gas mixture G₀ is hydrated to form a gas hydrate slurry in the gas hydrate formation part 2. The gas hydrate slurry preferably has a water content of 50 to 95 wt %. By the formation of CO₂ hydrate, 50 to 95 vol % of CO₂ gas in the gas mixture G₀ can be separated.

The residual gas (non-hydrated gas G₁) after the formation of gas hydrate of the one type of gas in the gas mixture G₀ in the gas hydrate formation part 2 is discharged out of the gas hydrate formation part 2.

Next, the gas hydrate slurry is delivered to the dehydration part 3, and a dehydration step is carried out to dehydrate the gas hydrate slurry until it has a water content of approximately 25 to 60 wt %, for example. Water W₁ removed in the dehydration part 3 is mixed with water W₂ which is generated when the gas hydrate is decomposed in the gas hydrate decomposition part 4, which is described later, and the mixed water is circulated back to the gas hydrate formation part 2 as circulating water CW. Reference numeral 16 indicates a line for delivering the circulating water CW.

The CO₂ hydrate dehydrated in the dehydration part 3 is decomposed and regasified in the gas hydrate decomposition part 4 (gas hydrate decomposition step). The decomposition of a gas hydrate requires heat of decomposition, and the decomposition of CO₂ hydrate needs heating to approximately 10° C. The gas hydrate decomposition part 4 is provided with a heating part 12 through which seawater with a temperature of 10 to 15° C. or low-temperature exhaust heat generated in a chemical plant, for example, is circulated. The heating part 12 may include a heater 13.

As the heat source for the heater 13, the heat which is generated when the gas mixture G₀ is compressed in the compressor 5 may be used. This leads to a reduction of decomposition heat energy necessary for the regasification.

When CO₂ is regasified in the gas hydrate decomposition part 4, the hydrate is decomposed to generate water. Because the gas hydrate decomposition reaction is an endothermic reaction and the water generated by the decomposition has a temperature of approximately 10 to 15° C., the water generated by the decomposition needs to be cooled to a low temperature suitable for the formation of the gas hydrate when it is circulated into the gas hydrate formation part 2 and reused.

In this embodiment, the dehydration part 3 is provided between the gas hydrate formation part 2 and the gas hydrate decomposition part 4, and the circulating water CW, which is a mixture of the water W₁ removed from the gas hydrate slurry in the dehydration part 3 and the water W₂ generated when the gas hydrate is decomposed in the gas hydrate decomposition part 4, is cooled in a cooler 14 and then introduced into the gas hydrate formation part 2. The temperature of the water W₁ removed from the gas hydrate slurry in the dehydration part 3 is as low as that in the gas hydrate formation part 2.

Because the temperature of the circulating water CW, which is a mixture of the water W₁ (with a temperature as low as that in the gas hydrate formation part) removed from the gas hydrate slurry in the dehydration part 3 and the water W₂ (with a slightly higher temperature) generated when the gas hydrate is decomposed in the gas hydrate decomposition part 4, is lower than that of the water W₂ generated when the gas hydrate is decomposed, the energy necessary to cool the circulating water CW can be reduced compared to the case where only the water W₂ generated when the gas hydrate is decomposed is returned to the gas hydrate formation part 2.

In addition, when the dehydration capacity of the dehydration part 3 is enhanced, the energy necessary to cool the circulating water CW can be further decreased because the amount of water W₁ (with a low temperature) removed from the gas hydrate slurry increases and the amount of water W₂ (with a slightly higher temperature), which is generated by decomposition of the gas hydrate, decreases. In addition, the decomposition heat energy necessary for the regasification decreases as the slurry concentration increases.

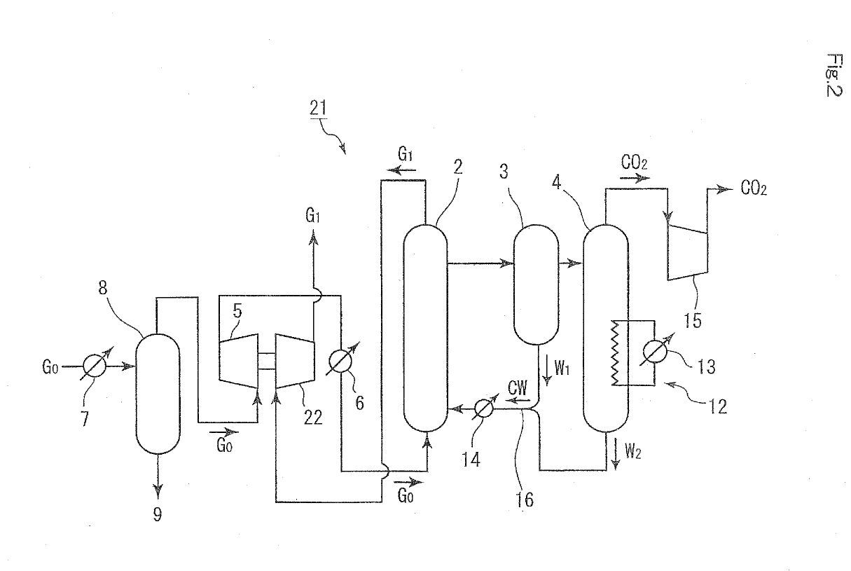

While the cooler 11 for cooling the water W₃ extracted from the gas hydrate formation part 2 and circulated through the line 10 and the cooler 14 for cooling the circulating water CW, a mixture of the water W₁ removed from the gas hydrate slurry and the water W₂ generated by the decomposition of the gas hydrate, are provided separately in this embodiment, the cooler 11 for cooling and circulating the water W₃ extracted from the gas hydrate formation part 2 may be omitted (refer to FIG. 2), and the temperature rise in the gas hydrate formation part 2 due to the heat of formation of CO₂ hydrate may be prevented only with the circulating water CW.

To remove the heat of formation of CO₂ hydrate and maintain the interior of the gas hydrate formation part 2 at a predetermined temperature suitable for the formation of CO₂ hydrate (approximately 4° C.), the circulating water CW is preferably cooled to approximately 0 to 1° C. in the cooler 14.

Because the CO₂ regasified in the gas hydrate decomposition part 4 has a pressure of approximately 3 to 4 MPa at the time of decomposition, the regasified CO₂ is pressurized to a pressure (for example, 10 to 15 MPa) suitable for pipeline transportation in a gas compressor 15 before transportation. The regasified CO₂ may be cooled to recover CO₂ in the form of a liquid.

The one type of gas to be separated from the gas mixture G₀ is not limited to the above embodiment, and a gas component which can be separated from the gas mixture G₀ by a hydration process can be selected among various types of gas including methane, ethane, propane, butane or hydrogen sulfide, and so on. It is needless to say that the pressure and temperature in the gas hydrate formation part 2, the dehydration part 3, the gas hydrate decomposition part 4 and so on should be changed depending on the gas component to be separated.

### Second Embodiment

Another embodiment of the gas mixture separation apparatus according to the present invention is described with reference to FIG. 2. The same components in a gas mixture separation apparatus 21 according to this embodiment as those of the first embodiment are designated by the same reference numerals and their description is omitted. A case where carbon dioxide (CO₂) in a gas mixture Gₒ is hydrated and separated is described as in the case with the first embodiment.

The residual gas (non-hydrated gas G₁) after the formation of CO₂ gas hydrate in the gas hydrate formation part 2 is discharged out of the gas hydrate formation part 2 with its pressure maintained at 5 to 20 MPa, high enough for the formation of CO₂ gas hydrate.

The compressor 5 of the gas mixture separation apparatus 21 according to this embodiment has a drive shaft provided with a power recovery part 22, such as a well-known gas expander (axial turbine), and the high-pressure gas (non-hydrated gas G₁) discharged out of the gas hydrate formation part 2 is delivered to the power recovery part 22 to use the pressure energy of the high-pressure gas as auxiliary power for the compressor 5. Instead of directly coupling the power recovery part 22, such as a gas expander, to the drive shaft of the compressor 5 as in this embodiment, the gas expander or the like may be coupled to a power generator to use the electric power from the power generator to drive a motor-driven compressor 5.

This configuration allows the pressure energy of the high-pressure gas G₁ after the hydration and separation of one type of gas in the gas mixture G₀ to be used as power for the compressor 5 to reduce the energy consumption in the compressor 5. It can be expected to reduce the energy consumption in the compressor 5 by 50% or more by the power recovery from the high-pressure gas G₁ of 5 to 20 MPa. Therefore, the overall operating cost of the apparatus can be reduced.

### Third Embodiment

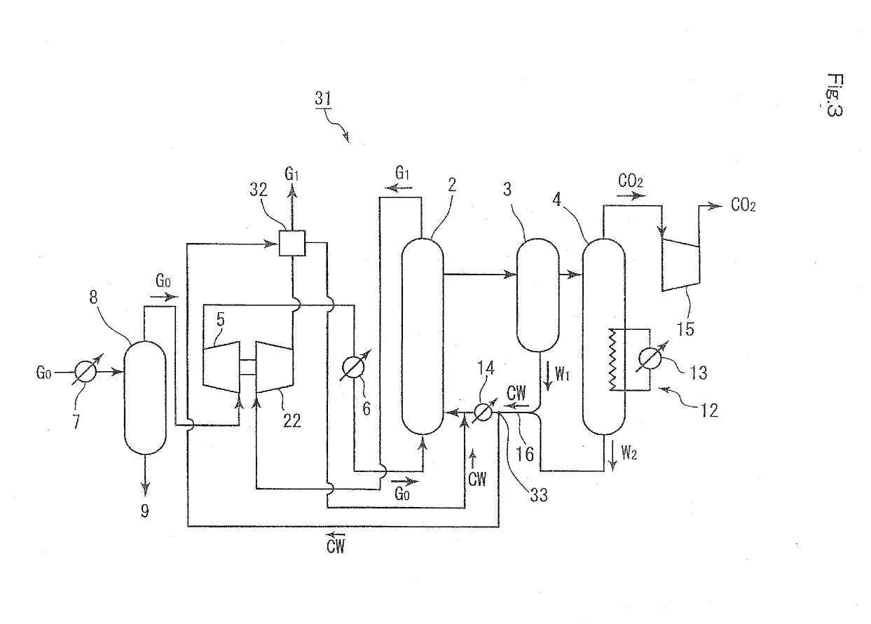

Yet another embodiment of the gas mixture separation apparatus according to the present invention is described with reference to FIG. 3. The same components in a gas mixture separation apparatus 31 according to this embodiment as those of the first and second embodiments are designated by the same reference numerals and their description is omitted. A case where carbon dioxide (CO₂) in a gas mixture G₀ is hydrated and separated is described as in the case with the first embodiment.

As described in the second embodiment, the high-pressure gas G₁ discharged out of the gas hydrate formation part 2 is delivered to the power recovery part 22 provided with the compressor 5 and returned to atmospheric pressure to recover its pressure energy. Here, when the high-pressure gas G₁ is returned to atmospheric pressure, cold energy is generated by the expansion of the gas. A gas mixture separation apparatus 31 according to this embodiment is provided with a cooling part 32, such as a heat exchanger, that utilizes the cold energy to cool the circulating water CW. In this embodiment, the maintenance of the temperature (prevention of temperature rise due to the heat of formation of CO₂ hydrate) in the gas hydrate formation part 2 is provided by the circulating water CW.

This allows the circulating water CW to be cooled by the cold energy generated when the non-hydrated high-pressure gas G1 is expanded to atmospheric pressure in the case where the pressure energy of the high-pressure gas G1 is used as power for the compressor 5. Thus, the energy consumption necessary to cool the circulating water CW can be reduced. It is expected to reduce the energy consumption necessary to cool the circulating water CW by approximately 40% by the use of the cold energy which is generated when the high-pressure gas G₁ of 5 to 20 MPa is returned to atmospheric pressure. Therefore, the overall operating cost of the apparatus can be reduced.

A three-way valve (not shown) or the like is preferably provided at a branch 33 in FIG. 3 so that the cooler 14 can be used as needed based on the degree of temperature rise in the gas hydrate formation part.

### Fourth Embodiment

The process gas in a chemical plant or a power generation system such as an integrated gasification combined cycle contains carbon dioxide (CO₂), and a process of removing CO₂ from the process gas is required in some cases. Here, a case where a gas mixture separation apparatus according to the present invention is used for the process gas in an integrated gasification combined cycle (which is hereinafter referred to as “IGCC”) is described.

IGCC is a power generation method, which involves gasification of coal and uses a combination of a gas turbine and a steam turbine to generate electric power, and is attracting attention because of its high efficiency in converting coal into energy. The power generation process in IGCC is described below.

First, coal is gasified to produce a gas mixture containing carbon dioxide (CO₂), carbon monoxide (CO), hydrogen (H₂), water (H₂O), and so on. Next, the CO contained in the mixed gas is converted into H₂ and CO₂ by a water-gas-shift reaction to produce a process gas containing CO₂ and H₂. The mix ratio of CO₂ and H₂ in the process gas is usually approximately 4:6.

The CO₂ is separated from the process gas, and the H₂ gas is burned in a gas turbine to generate electric power. The steam generated through the combustion of the H₂ gas in the gas turbine is also used in a steam turbine to generate electric power.

Here, in the process gas, hydrogen (H₂) is a useful gas component which can be used for the combustion power generation by means of the gas turbine, whereas carbon dioxide (CO₂) is a useless gas component which is not used for the combustion power generation by means of the gas turbine.

The separation of CO₂ from the process gas containing CO₂ and H₂ is currently carried out by a physical absorption method, but the method has the problems including environmental pollution due to leakage of the chemical used (absorbing liquid) and the cost of the chemical.

The gas mixture separation apparatus according to the present invention is advantageous in that the impact on the environment caused by the use of a chemical (absorbing liquid) can be reduced because it uses only water to separate CO₂ and can concentrate H₂ gas to be refined and in that it requires less energy.

In addition, various types of chemical process gases are similar in composition and pressure to the process gas in IGCC and can therefore utilize a CO₂ separation process in the gas mixture separation apparatus according to the present invention.

In addition, because the process gas has a pressure of 3 to 5 MPa, a benefit in cost can be expected because less energy is required to increase the pressure of the process gas as the gas mixture G₀ to a level suitable for the formation of CO₂ gas hydrate and it is, therefore, believed that the total energy consumption necessary to separate CO₂ from the gas mixture G₀ can be reduced.

The CO₂ separated from the process gas as a useless gas component in the combustion power generation by means of the gas turbine can be used effectively for another purpose.

### Fifth Embodiment

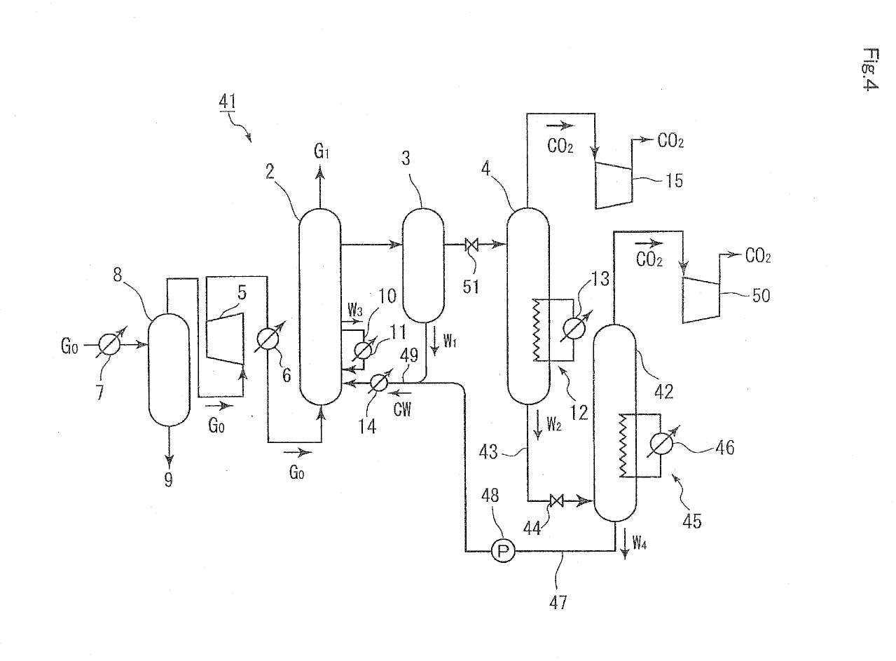

Still yet another example of the gas mixture separation apparatus according to the present invention is next described. FIG. 4 is a schematic configuration diagram illustrating a gas mixture separation apparatus 41 according to a fifth embodiment. The same components as those of the gas mixture separation apparatus of the first embodiment are designated by the same reference numerals and their description is omitted. A case where carbon dioxide (CO₂) in a gas mixture G₀ is hydrated and separated is described as in the case with the first embodiment.

The gas mixture separation apparatus 41 according to this embodiment has a gas hydrate formation part 2, dehydration part 3, and a gas hydrate decomposition part 4 as in the case with the first embodiment, and is additionally provided with a gas release part 42. When carbon dioxide in a gas mixture G₀ is hydrated, the gas hydrate formation part 2 is set to a pressure of 5 to 20 MPa, preferably 6 to 9 MPa, and a temperature of 0 to 4° C., preferably 2 to 4° C., for example, and the gas hydrate decomposition part 4 is set to a pressure of 1 to 5 MPa and a temperature of 10 to 15° C., for example.

The gas release part 42 receives the water W₂, which is obtained as a result of regasification of gas hydrate in the gas hydrate decomposition part 4. Reference numeral 43 indicates a line for delivering the water W₂, and reference numerals 44 and 51 indicate a valve. Other lines connecting the constituent components may be provided with a valve (not shown in the drawing) as needed.

The gas release part 42 is described in more detail. The gas release part 42 is a constituent part for carrying out a gas release process to release a gas dissolved in the water W₂ obtained as a result of the regasification in the gas hydrate decomposition part 4. The gas release part 42 has a heating part 45 provided with a heater 46 so that a gas dissolved in the water contained as a result of the regasification can be released by adjusting the pressure and temperature in the gas release part 42 to predetermined levels. In this embodiment, in which carbon dioxide is separated from the gas mixture, the pressure and temperature in the gas release part 42 are set at 0.2 to 0.5 MPa and at approximately 10° C., respectively, for example.

Because approximately 20 kJ of releasing heat is necessary to release one mole of carbon dioxide contained in water, circulating seawater having a temperature of approximately 10 to 15° C. or low-temperature exhaust heat from a chemical plant may be used as the heater 46. The gas (carbon dioxide) released in the gas release part 42 is transported after being pressurized to a pressure suitable for pipeline transport (such as 10 to 15 MPa) in a gas compressor 50, for example. The regasified CO₂ may be cooled to recover CO₂ in the form of a liquid.

Water W₄ passed through the gas release part 42 (water W₄ after the release and removal of carbon dioxide) is discharged out of the gas release part 42 and mixed with the water W₁ removed in the dehydration part 3, and the mixed water is returned to and circulated through the gas hydrate formation part 2 as circulating water CW. Reference numeral 47 indicates a line through which the water W₃ is delivered, and reference numeral 49 indicates a line for delivering the circulating water CW, which is a mixture of the water W₁ and the water W₃. The line 47 is provided with a pump 48. Other lines connecting the constituent components may be provided with a pump as needed.

The operation of the gas mixture separation apparatus 41 of this embodiment is next described. The gas (carbon dioxide in this embodiment) separated from the gas mixture is dissolved in the water obtained as a result of regasification of the gas hydrate in the gas hydrate decomposition part 4. In general, the solubility of a gas in water tends to increases as the pressure increases and the temperature decreases. In particular, it is known that carbon dioxide has much higher water solubility than other gas components (such as hydrogen and nitrogen) contained in the gas mixture, and the dissolution of the gas in the water decreases the gas separation efficiency.

Here, if the hydrate is decomposed at a higher temperature in the gas hydrate decomposition part 4, the dissolution of the gas in the water decreases. However, when the water increased in temperature is returned to the gas hydrate formation part 2, the energy consumption necessary to cool the water (circulating water CW) increases. On the other hand, if the hydrate is decomposed at a lower pressure in the gas hydrate decomposition part 4, the dissolution of the gas in the water decreases. However, when the gas hydrate is delivered from the dehydration part 3 to the gas hydrate decomposition part 4, the pressure in the gas hydrate decomposition part 4 must be increased to a level at which the gas hydrate does not decompose (as high as that in the dehydration part 3) and the energy consumption necessary to pressurize the gas hydrate decomposition part 4 again increases.

In this embodiment, the gas release part 42 is provided separately from the gas hydrate decomposition part 4. Thus, when the gas hydrate is decomposed in the gas hydrate decomposition part 4, a higher temperature can be applied as a gas hydrate decomposition condition without reducing the pressure so much. As a result, the difference in pressure condition between the dehydration part 3 and the gas hydrate decomposition part 4 can be small. Then, when the water W₂ obtained by the decomposition of the gas hydrate is delivered to the gas release part 42 and the gas (CO₂) dissolved in the water W₂ is released in the gas release part 42, the temperature in the gas release part 42 can be set low because the gas can be released from the water W₂ by setting the pressure in the gas release part 42 low.

When the pressure in the gas release part 42 is set low, the pressure in the gas hydrate decomposition part 4 decreases when the water W₂ is transported from the gas hydrate decomposition part 4 to the gas release part 42, but it is only necessary to pressurize the gas hydrate decomposition part 4 to compensate for the pressure drop that occurs during the transportation of the water W₂. Thus, the energy consumption necessary to repressurize the gas hydrate decomposition part 4 can be reduced compared to the case where the dissolution of the gas obtained by the decomposition of the gas hydrate in the water W₂ is reduced by decreasing the pressure in the gas hydrate decomposition part 4 as described above.

The water W₃ passed through the gas release part 42 is mixed with the water W₁ removed from the gas hydrate slurry in the dehydration part 3 and the mixed water is introduced into the gas hydrate formation part 2 as circulating water CW. Because the gas release part 42 is provided separately from the gas hydrate decomposition part 4, there is no need to increase the temperature of the water to release the gas because the gas can be released by reducing the pressure. Therefore, the energy necessary to cool the water to be returned to the gas hydrate formation part 2 as the circulating water CW can be reduced. Preferably, heating is carried out to an extent that compensates for the releasing heat that is necessary to release the gas from the water W₂ in the gas release part 42.

As described above, the gas separation efficiency can be improved by releasing the gas in the water W₂ obtained as a result of regasification of the gas hydrate in the gas hydrate decomposition part 4, and cost reduction can be achieved by reducing the energy consumption necessary to operate the gas mixture separation apparatus 41. This embodiment is especially useful in hydrating and separating a gas having high water solubility, such as carbon dioxide, oxygen, hydrogen sulfide and sulfur dioxide (sulfurous acid gas), from a gas mixture.

In addition, a gas mixture separation apparatus with higher energy efficiency can be achieved when configured to use the energy of the high-pressure gas (non-hydrated gas G₁) released from the gas hydrate formation part 2 as auxiliary power for the compressor 5 as in the second embodiment or to cool the circulating water CW by cold energy generated when the high-pressure gas G₁ is expanded to atmospheric pressure when the pressure energy of the non-hydrated high-pressure gas G₁ is used as power for the compressor 5 as in the third embodiment.

### INDUSTRIAL APPLICABILITY

The present invention is applicable to apparatus and method for separating one type of gas contained in a gas mixture containing a plurality of gas components.

1. A gas mixture separation apparatus, comprising:
a gas hydrate formation part for hydrating one type of gas contained in a gas mixture containing a plurality of gas components to form a gas hydrate slurry,
a dehydration part for dehydrating the gas hydrate slurry, and
a gas hydrate decomposition part for decomposing and regasifying the gas hydrate obtained by the dehydration,
wherein the water removed from the gas hydrate slurry in the dehydration part and the water generated when the gas hydrate is decomposed in the gas hydrate decomposition part are mixed together and the mixed water is introduced into the gas hydrate formation part as circulating water.

2. A gas mixture separation apparatus, comprising:
a gas hydrate formation part for hydrating one type of gas contained in a gas mixture containing a plurality of gas components to form a gas hydrate slurry,
a dehydration part for dehydrating the gas hydrate slurry,
a gas hydrate decomposition part for decomposing and regasifying the gas hydrate obtained by the dehydration, and
a gas release part for receiving the water obtained as a result of the regasification in the gas hydrate decomposition part and releasing the one type of gas dissolved in the water,
wherein the water removed from the gas hydrate slurry in the dehydration part and the water passed through the gas release part are mixed together and the mixed water is introduced into the gas hydrate formation part as circulating water.

3. The gas mixture separation apparatus according to claim 1 or 2,
further comprising a compressor, provided upstream of the gas hydrate formation part, for pressurizing the gas mixture to a predetermined pressure,
wherein the pressure energy of non-hydrated high-pressure gas discharged from the gas hydrate formation part is used as power for the compressor.

4. The gas mixture separation apparatus according to claim 3,
further comprising a cooling part for cooling the circulating water using the cold energy which is generated when the high-pressure gas is expanded to atmospheric pressure.

5. The gas mixture separation apparatus according to any one of claims 1 to 4,
wherein the gas that is hydrated is carbon dioxide.

6. The gas mixture separation apparatus according to any one of claims 1 to 5,
wherein the gas mixture is a mixed gas of a useful gas component and a useless gas component, and the gas that is hydrated is the useless gas component.

7. A gas mixture separation method, comprising:
a gas hydrate formation step of hydrating one type of gas contained in a gas mixture containing a plurality of gas components to form a gas hydrate slurry,
a dehydration step of dehydrating the gas hydrate slurry, and
a gas hydrate decomposition step of decomposing and regasifying the gas hydrate obtained by the dehydration,
wherein the water removed from the gas hydrate slurry in the dehydration step and the water generated when the gas hydrate is decomposed in the gas hydrate decomposition step are mixed together and the mixed water is circulated as water for use in forming the gas hydrate in the gas hydrate formation step.

8. A gas mixture separation method, comprising:
a gas hydrate formation step of hydrating one type of gas contained in a gas mixture containing a plurality of gas components to form a gas hydrate slurry,
a dehydration step of dehydrating the gas hydrate slurry,
a gas hydrate decomposition step of decomposing and regasifying the gas hydrate obtained by the dehydration, and
a gas release step for receiving the water obtained as a result of the regasification in the gas hydrate decomposition part and releasing the one type of gas dissolved in the water,
wherein the water removed from the gas hydrate slurry in the dehydration step and the water passed through the gas release step are mixed together and the mixed water is circulated as water for use in forming the gas hydrate in the gas hydrate formation step.

9. The gas mixture separation method according to claim 7 or 8,
wherein the gas that is hydrated is carbon dioxide.
